(19) United States
(12) Patent Application Publication
(10) Pub. No.: US 2005/0182670 A1
(43) Pub. Date: Aug. 18, 2005

(54) Methods for reducing and eliminating risk exposure in life insurance transactions

(76) Inventor: Steven A. Burgess, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/060,961

(22) Filed: Feb. 18, 2005

Related U.S. Application Data
(60) Provisional application No. 60/545,521, filed on Feb. 18, 2004.

(51) Int. Cl. G06F 17/60

(52) U.S. Cl. 705/4; 705/35

(57) ABSTRACT

A method for arranging a life insurance transaction while managing risk exposure associated with the transaction is disclosed. In one embodiment, the method includes coordinating the initiation of an insurance policy that relates to the life of a person. Execution of a loan on behalf of an owner of the policy for the payment of premiums due on the policy is also coordinated with a lending entity. The posting of collateral for the loan by a third party is coordinated, thereby removing risk exposure from the lending entity, the policy owner, and/or the insured.

### CROSS-REFERENCE TO RELATED APPLICATIONS

This application claims the benefit of U.S. Application No. 60/545,521, entitled “Elimination of Risk Exposure in Life Insurance Transactions,” filed Feb. 18, 2004, which is incorporated herein by reference in its entirety.

### BACKGROUND OF THE INVENTION

1. The Field of the Invention

The present invention generally relates to arranging insurance transactions. More particularly, the present invention relates to methods for providing life insurance policies to insured persons while reducing or eliminating associated financial risk to the parties involved in the insurance transaction.

2. The Related Technology

Financial investment strategies today are replete with various means by which persons can manage their assets so as to reduce government taxation. One popular means has involved life insurance coverage, a mechanism by which a death benefit is paid to the beneficiary of the life insurance policy upon the death of the insured person.

Notwithstanding its utility for preserving and perpetuating wealth, some forms of life insurance coverage carry with them various challenges. First, life insurance policies having high death benefit amounts, such as multi-million dollar policies, carry very high premiums, especially for insureds of advanced age. Second, the death benefit associated with such policies, if not optimally structured, can be subject to severe estate taxation, which can whittle down much of the policy's value.

In response to the above, specialized life insurance programs have been developed in an attempt to overcome the above challenges. One of these programs is known as premium financed life insurance policies. In a premium financed policy, the insured secures a loan with a lending institution (“lender”) for the payment of premiums charged by an insurance provider on a life insurance policy on the life of the insured. In return, the insured agrees to repay the loan principal, plus any fees and interest (collectively referred to as “loan balance”), to the lender during the life of the loan (“term loan period”). The loan balance can be repaid in periodic installments by the insured during life, or by the policy at the time of the insured's death. This scheme enables the life insurance policy premiums to be timely paid, while freeing up assets of the insured that would otherwise be applied to the policy premiums.

As explained above, standard premium financed policies assist in partially overcoming the first challenge to life insurance for advanced-age insureds, that of high insurance premiums. In partial response to the second problem above, i.e., high estate taxation on policy death benefits, other programs must be employed. One of these programs involves the use of an irrevocable life insurance trust (“ILIT”).

As its name implies, an ILIT is an irrevocable trust into which a grantor irrevocably transfers property. In the present case, the ILIT is employed within a premium financed scheme to remove ownership of a premium financed life insurance policy from the grantor-insured and transfer that ownership to the trust. So configured, the premiums for the policy, which is now owned by the ILIT, are paid on behalf of the trust by the lender to the insurance provider, pursuant a loan executed by the trust with the lender to secure repayment of the loan balance. Upon death of the grantor-insured, the loan balance is paid to the lender pursuant an assignment on the life policy death benefit issued by the insurance provider. The remainder of the death benefit is then forwarded to the heirs of the grantor-insured.

Use of the ILIT as explained here helps eliminate estate taxation problems for the insured with respect to the life insurance policy by removing control of the policy from the insured, thereby severing the policy from the estate and preventing the death benefit from being subject to estate tax assessments.

Notwithstanding the solutions presented by the premium financed and ILIT insurance strategies described above, new challenges are also presented. Primary among the challenges is an element of risk that is introduced for the insured in collateralizing the loan made by the lender to fund the life insurance premiums. During the pendency of the loan made to fund the premiums of the insurance policy held by the ILIT, the policy itself is secured by the lender as collateral against the loan. In addition, the insured is required to post a predetermined amount of additional collateral against the loan in order to protect the lender from any exposure resulting from the difference between the loan balance and the policy's accumulated cash value. Collateral provided by the insured can include liquid assets such as cash, but typically a letter of credit is used. The collateral therefore protects the lender from such exposure in the event of default or the calling or non-renewal of the loan. Should this occur, the insured will lose some or all the posted collateral in order to satisfy any shortfall in the policy cash value in meeting the unpaid loan balance. As such, collateral posting represents a risk of loss for the insured and can lessen the attractiveness of premium financed and premium financed-ILIT policies for insured persons.

In addition, the risk associated with collateral posting by the insured can be exacerbated in certain economic circumstances when the interest rate charged in connection with the premium financed loan exceeds the crediting rate, i.e., the interest rate that determines earnings on the policy cash value for an extended period of time. This scenario, known as negative arbitrage, can further drive up the amount of collateral that must be posted by the insured, which in turn undesirably increases the insured's risk.

In light of the above, a need exists in the life insurance, estate planning, and investment industry for a strategy by which the above challenges and risks are reduced or eliminated. In particular, strategies for effectively creating premium financed life insurance policies that reduce or eliminate risk of loss to the insured are in need. Any proposed solution should also represent an attractive solution to the risk-adverse other parties involved in life insurance transactions, including the lender, the life insurance provider, and interested third parties.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram showing various details regarding a method for implementing a premium financed life insurance policy transaction, according to one embodiment of the present invention;

FIG. 2 is a block diagram showing various stages of a method relating to the transaction depicted in FIG. 1, according to one embodiment;

FIGS. 3A-3D are various views of a chart showing various aspects of a life insurance transaction, such as the transaction depicted in FIG. 1, according to one embodiment;

FIG. 4 is a block diagram showing various details regarding a method for implementing a premium financed life insurance policy transaction, according to another embodiment of the present invention;

FIG. 5A is a chart showing various aspects of a life insurance transaction, such as the transaction depicted in FIG. 1, according to one embodiment;

FIG. 5B is a chart showing various aspects of a life insurance transaction, such as the transaction depicted in FIG. 1, according to one embodiment;

FIG. 6 is a block diagram showing various details regarding a method for implementing a premium financed life insurance policy transaction, according to another embodiment of the present invention;

FIG. 7 is a block diagram showing various stages of a method relating to the transaction depicted in FIG. 6, according to one embodiment;

FIGS. 8A-8D are various views of a chart showing various aspects of a life insurance transaction, such as the transaction depicted in FIG. 6, according to one embodiment;

FIGS. 9A-9B are various views of a chart showing various aspects of a life insurance transaction, according to one embodiment; and

FIGS. 10A-10B are various views of a chart showing various aspects of a life insurance transaction, according to yet another embodiment.

### DETAILED DESCRIPTION OF THE PREFERRED EMBODIMENTS

Reference will now be made to figures wherein like structures will be provided with like reference designations. It is understood that the drawings are diagrammatic and schematic representations of presently preferred embodiments of the invention, and are not limiting of the present invention nor are they necessarily drawn to scale.

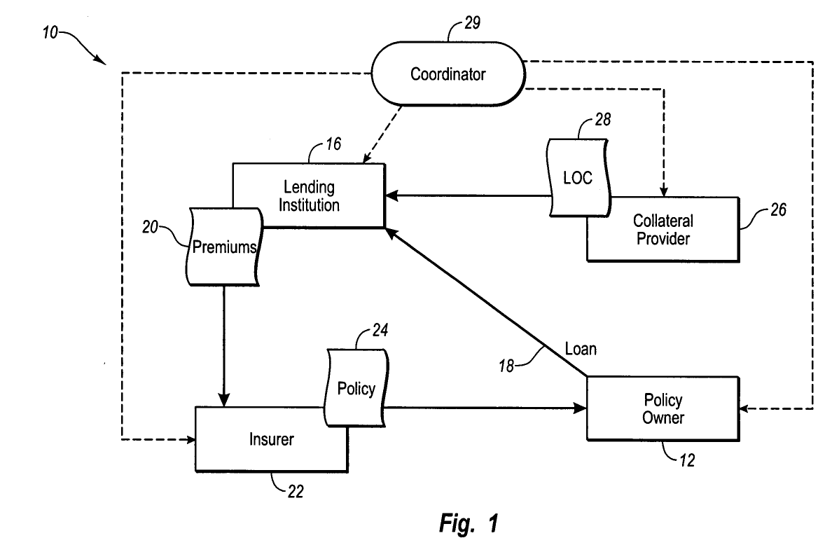

FIGS. 1-6 depict various features of embodiments of the present invention, which is generally directed to a method of arranging life insurance transactions to reduce or eliminate risks traditionally associated with such policies. Practice of the embodiments contained herein can allow parties to a life insurance policy to participate in the transaction without fear of adverse financial loss in the manner encountered in previous transactions.

Reference is first made to FIG. 1, which shows various features of a transaction scenario, generally depicted at 10, in accordance with embodiments of the present invention. In detail, FIG. 1 shows various entities involved in a premium financed life insurance transaction of one embodiment of the present invention. A policy owner 12 is shown, and represents a person or entity owning a life insurance policy, to be described later, that is issued on the life of a specified person (the “insured”). In the present embodiment, and as will be described in the present discussion, the policy owner 12 and the insured are the same person. However, in other embodiments, the policy owner 12 can be a person or entity other than the insured, such as a trust, for example.

In one embodiment, the insured is a person of relatively high net worth, i.e., a person who qualifies under accepted insurability standards for at least $1 million of life insurance coverage, and of advanced age, that is, a person of 75 years of age or more. In other embodiments, persons of a younger age but having a net worth of $3 million can be insured using the methods disclosed herein. Note, however, that in other embodiments the insured can also have a net worth of less than $1 million, and can be aged younger than 75, depending on the particular life insurance transaction to be executed. Thus, it is appreciated that one aspect of the method described herein is the ability to insure persons of more moderate means and age than what was previously feasible.

A lending entity, such as a lending institution (“lender”) 16, is employed to provide financing for the premiums due on the policy owned by the policy owner 12. In return for payment of the premiums on behalf of the policy owner 12, the policy owner is obligated to repay to the lender the total premium amount, plus any fees and interest (collectively referred to as the “loan balance”) accrued on the loan. The loan executed between the policy owner 12 and the lender 16 can take one of various forms, and is indicated in FIG. 1 by an arrow 18.

Repayment of the loan balance is typically paid in installments during the pendency of the loan, referred to herein as the “term loan period,” though repayment could be achieved via a lump sum payment during the term loan period. In the event of the death of the insured policy owner 12, repayment to the lender 16 of any unpaid loan balance is achieved via an assignment on the death benefit of the life insurance policy in favor of the lender. Should the loan or policy be prematurely cancelled for some reason, the lender 16 can recover the unpaid loan balance via an assignment of both the accumulated cash value of the policy and any required collateral posted in connection with the loan, as described further below.

Payment of premiums, indicated at 20, by the lender 16 is made to an insurance provider (“insurer”) 22 or similar entity capable of issuing a life insurance policy. In return for premium payment, which is typically executed via annual payments, the insurer 22 issues a contract, or policy 24, on the life of the insured to the policy owner 12. As is well known, upon the death of the insured, the policy owner 12 or other designated party receives the net proceeds of the death benefit of the policy 24, following payment from the death benefit to the lender 16 to cover the loan balance at the time of death, as well as any other necessary costs and fees.

As has been discussed, during the term loan period the cash value of the policy 24 may be exceeded by the loan balance, which can represent an exposure risk for the lender 16 should a call on the loan be executed. In premium financed transactions, this exposure risk is ameliorated by the securing, or posting, of collateral for the loan. In typical premium financed transactions, the collateral includes the cash value of the policy 24 itself, as well as additional collateral posted by the insured. One common type of collateral that is posted by the insured includes a letter of credit. As was explained, this represents a source of risk to the insured.

FIG. 1 further depicts various features of a method for reducing risk exposure in a life insurance transaction, according to one embodiment of the present invention. In detail, FIG. 1 further depicts a collateral provider 26, such as an individual, financial institution, insurance provider, or other suitable entity, that is willing to post the collateral, referred to above, that is necessary to secure the loan provided by the lender 16 in the premium financed transaction discussed above. In one embodiment, the collateral is in the form of a letter of credit (“LOC”), indicated at 28 in FIG. 1, which is posted by the collateral provider 26 on behalf of the policy owner 12 for the benefit of the lender 16, ie., the parties to the loan. In other embodiments, however, the collateral can represent other forms, such as, for example, cash or other liquid assets. Posting of the collateral by a third party eliminates risk exposure to the policy owner/insured, as the collateral obligation is carried by the collateral provider 26. In return for posting the letter of credit 28 and thereby assuming some risk exposure, the collateral provider 26 is paid a fee that in one embodiment is a percentage of the amount of collateral provided, e.g., 10%. Further details regarding this arrangement are discussed below.

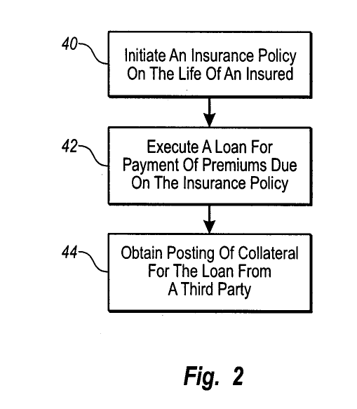

With continuing reference to FIG. 1, reference is now made to FIG. 2. In accordance with the details depicted in FIG. 1, a method is disclosed in FIG. 2 for arranging a life insurance transaction having controlled risk exposure for the policy owner 12/insured, in accordance with one embodiment. In a first stage 40, an insurance policy on the life of an insured is opened. This can be accomplished via an insurance agent, insurance broker, or other suitable entity. In the transaction depicted in FIG. 1, for example, the life insurance policy 24 is opened by the insurer 22 on the life of the policy owner 12. In recognition of the fact that many species of life policies exist, the life insurance policy 24 of the present embodiment can take a variety of forms and be configured in a variety of ways. For example, in one embodiment the policy owner can be someone or some entity other than the insured or a trust, but rather anyone who has an insurable interest in the insured.

In a next stage 42, a loan for the payment of premiums relating to the life insurance policy opened in stage 40 is executed. In the present transaction shown in FIG. 1, the executed loan is represented at 18 and is established between the policy owner 12, who in this case is the insured, and the lender 16. Once the loan is executed, payment of the premiums is made by the lender 16 to the insurer 22 to keep the policy 24 in force on behalf of the policy owner 12. The financing of premiums in this manner is known as “premium financing.” As was the case with the life insurance policy above, the loan for the payment of policy premiums can take a variety of forms, according to the parties involved, the particular economic situation in which the loan is executed, policy payment goals to be achieved, etc.

In a next stage 44, a posting of collateral by a third party is obtained to secure repayment of the loan, i.e., the loan at 18 shown in FIG. 1. Again, in accordance with embodiments of the present invention, the collateral posting is performed by a third party and not by the policy owner 12 (insured), thereby shielding the policy owner (insured) from risk exposure created by the collateral posting. In FIG. 1, the third party is represented as the collateral provider 26, and the collateral posted in favor of the lender 16 is the LOC 28.

In one embodiment, the execution or coordination of one or more of the stages 40-44 can be accomplished by a coordinator, such as coordinator 29 shown in FIG. 1. The coordinator 29 can be a person, such as an insurance agent, financial planner, or other person, business operation, or entity that can assist in identifying the various parties shown in FIG. 1 and in coordinating their interrelation and participation within a premium financed life insurance transaction as is described herein. This coordination is indicated in FIG. 1 by phantom lines.

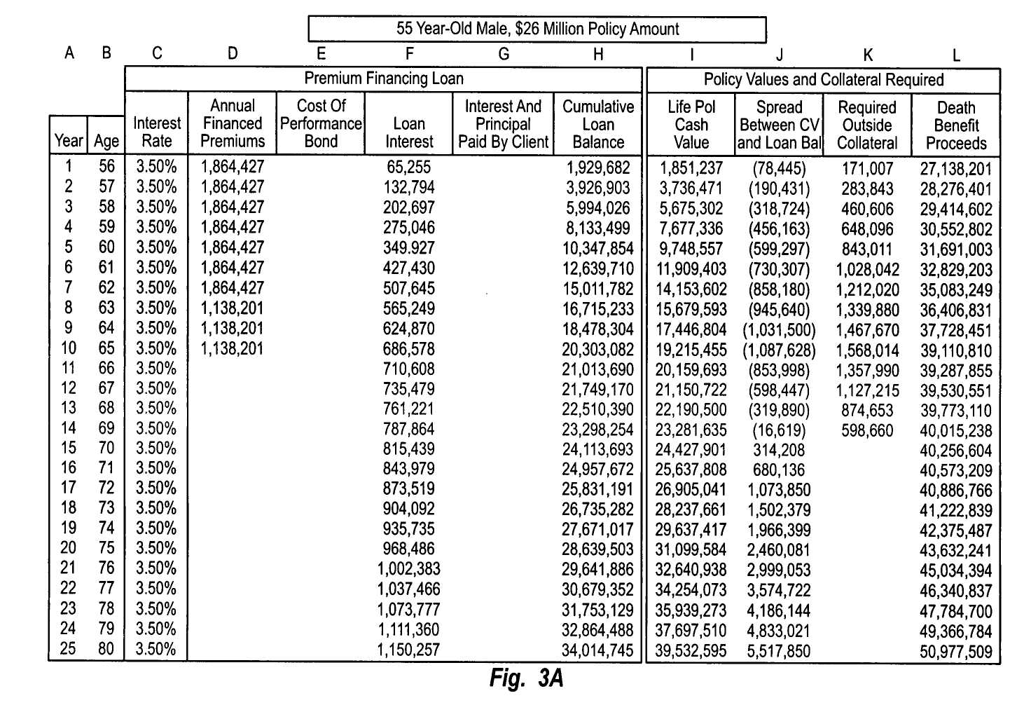

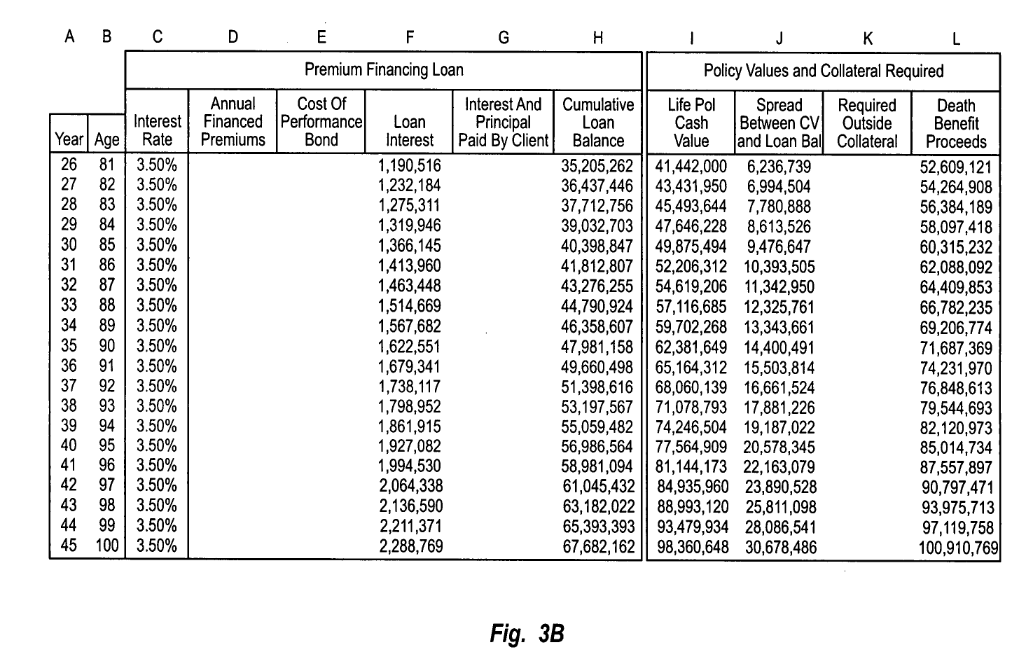

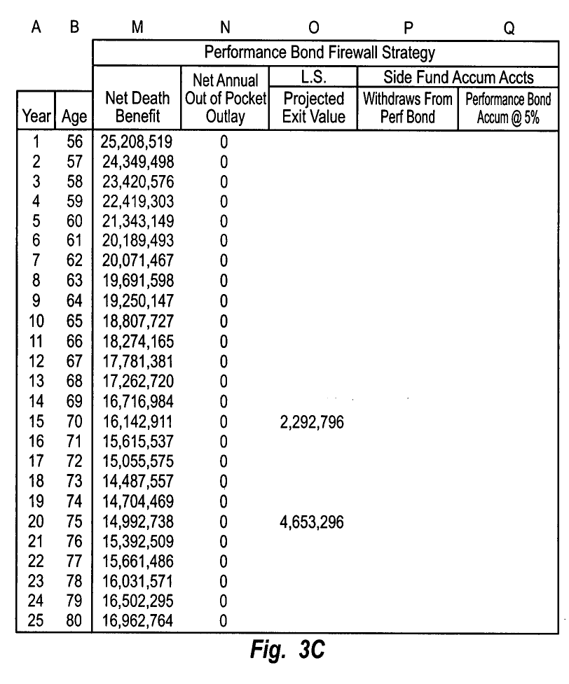

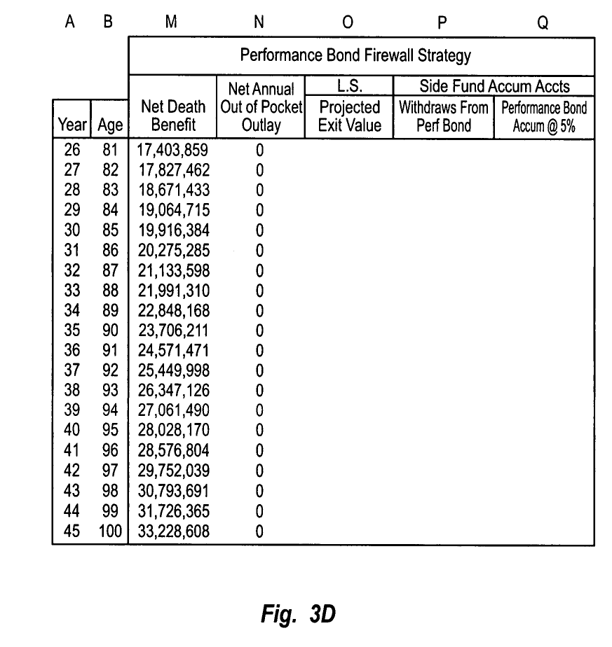

With continuing reference to FIGS. 1 and 2, reference is now made to FIGS. 3A-D , which show an exemplary implementation of the method discussed above in connection with FIGS. 1 and 2. In particular, FIGS. 3A-D depict a chart showing a premium financed life insurance transaction scenario involving a $26 million life insurance policy on the life of a 55-year old male insured. The chart of FIGS. 3A-D includes various columns A-Q that include various details regarding the premium financed life insurance transaction, including various aspects of the method shown in FIG. 2, according to one embodiment of the present invention. The parties to the transaction are those shown in FIG. 1.

Column A chronologically lists the years in which the policy is active. Here, years 1-45 are shown. Correspondingly, the respective age of the policy owner 12, who in this case is the insured, is shown in column B, and runs from age 56 at year 1 of the policy to age 100 at policy year 45. Of course, it is appreciated that the insured may die before year 45 of the policy, and this scenario will be presented below.

Column C shows the interest rate at which the loan, such as the loan indicated at 18 in FIG. 1, is financed. Though the rate shown here in column C is held steady at 3.5% during the life of the policy, it can also fluctuate according to the various known economic factors, as will be discussed further below.

As has been described in connection with FIGS. 1 and 2, a life insurance policy is opened on the life of the insured. The death benefit of this policy is shown for each policy year (column A) in column L. The premiums to be paid the insurer, i.e., the insurer 22 in FIG. 1, are financed and paid by the lender, i.e., the lender 16, in connection with a premium financed scenario, as has been described. In the transaction shown in FIGS. 3A-D , the policy premiums are paid in ten yearly installments of approximately $1.86 million and $1.14 million from policy years 1-10, as shown in column D. The length of the loan, known as the term loan period, is 15 years in the present example, and is typically renewed by the lender 16. Other term loan periods can also be used.

The accruing interest on the loan, i.e., the financed policy premiums paid by the lender, is charged by the lender 16 to the policy owner 12, and is shown in column F. Column H, then, shows the cumulative loan balance for the loan for each policy year as a sum of the financed premiums (col. D) and loan interest (col. F), in addition to the previous year's loan balance. Column E and G are not used here.

Column I shows the accumulating cash value of the policy throughout the policy years, typically as a result of investment of the policy premiums, which yield earnings according to a rate of investment return known as a crediting rate. Comparison of columns H and I will reveal that, for the first 14 years of the policy, the loan balance exceeds the policy cash value. Column J indicates the amount of discrepancy, or spread, between columns H and I for each policy year. Thus, in policy years 1-14, the spread is negative, while subsequent to year 14, a positive spread exists, indicating that more cash value exists than loan balance.

In return for financing the payment of premiums, the lender 16 receives an assignment on the death benefit of the policy 24 equal to the loan balance at the time of death of the policy owner 12. In addition, the lender 16 receives an assignment of the policy cash value should the policy be cancelled for some reason before death occurs. However, this assignment may not be sufficient to cover the exposure of the lender 16 should policy cancellation occur while the loan balance exceeds the policy cash value, such as during policy years 1-14, thereby representing a risk exposure for the lender. To compensate for this exposure, a specified amount of collateral is required to be posted to cover the maximum risk exposure of the lender 16 during the policy life. The amount of collateral required for the present policy is shown in column K, and varies according to the fluctuation of the loan balance to policy cash value spread shown in col. J. Comparison of col. K with col. J reveals that the required collateral is greater for a given policy year than the spread between the loan balance and the policy cash value. This is due to collateral requirements typically imposed by the lender 16.

In contrast to known scenarios, in one embodiment of the present invention the collateral required by the lender 16 to be posted is not provided by the policy owner 12 or the insured. Rather, a third party, ie., the collateral provider 26 of FIG. 1, is arranged to provide the needed collateral. In one embodiment, the collateral provider 26 posts collateral in an amount sufficient to cover the maximum projected exposure of the lender 16 during the policy life. As seen in col. K of FIGS. 3A-D, the required collateral amount is approximately $1.57 million, which occurs in policy year 10. Thus, the collateral provider 26 posts a letter of credit, i.e., the LOC 28, or other acceptable collateral of at least this amount, to cover any exposure of the lender during the policy years where collateral above and beyond the value of the policy itself is required.

After policy year 14, the LOC 28 is no longer needed, and it can be retired by the collateral provider 26, preferably in agreement with the lender 16. In another embodiment, the LOC is posted for the duration of the term loan period, which in the present embodiment is 15 years, with possibility of renewal. In return for posting the collateral and assuming the related exposure risk, the collateral provider 26 can be compensated via a fee, such as 10% of the posted collateral value. The fee can be paid by the policy owner 12. In this way, exposure risk of the policy owner 12 or insured is avoided, thereby making the transaction more attractive to those in the senior aged market. Also, should the policy owner die within the term loan period, the collateral provider is paid an additional fee, such as 10% of the posted collateral value, to compensate for any collateral loss.

Column L shows the death benefit proceeds should for death of the insured occurring in any one of the policy years. As shown in col. L, the death benefit amount varies according to year, due to one or more rider policies placed on the policy 24 to ensure a net death benefit of at least $14 million. Such riders, however, are not necessary in connection with embodiments of the invention.

Column M shows the net death benefit that is distributed to beneficiaries upon the death of the insured. The net death benefit represents the remainder of the death benefit proceeds shown in col. L after deduction of the loan balance and any fees of col. H from the proceeds by the lender 16.

Column N shows that the financial expense to the policy owner 12 of the present life insurance transaction is zero. Indeed, no money is either paid or posted by the policy owner 12, thus reflecting the advantageous lack of risk exposure to the policy owner.

Embodiments of the present invention as explained in connection with FIGS. 1-3D can be practiced in insuring insured persons of a variety of ages, but is practiced in one embodiment within a senior-aged market, i.e., aged 55 years and above to at least age 90½ years.

At some point during or at the conclusion of the term loan period, the policy owner 12 may wish to sell the policy 24 as a life settlement in a secondary life settlement market. In one embodiment, policy sale occurs well within the term loan period but after any period of incontestability set by the lender 16 for the policy 24. In the present embodiment, a life settlement sale of the policy 24 occurs at year 15 of the policy, as shown in column 0, netting approx. $2.3 million for distribution by the policy owner 12, after the loan balance is retired. The value of the policy 24 as a life settlement can increase should additional health challenges arise for the insured. Alternatively, only a portion of the policy 24 can be sold as a life settlement, with the proceeds being employed, such as via a single premium immediate annuity (“SPIA”), to fund the premiums for the remainder of the policy that was not liquidated. Proceeds from a life settlement sale can also be used to fund a fully premium paid-up life insurance policy for the remainder of the life of the insured, if desired.

In addition to a life settlement sale, the policy 24 can be handled in various ways upon or near expiration of the term loan period. For instance, at term loan period expiration, the lender 16 can choose to renew the term loan period, in this instance 15 years, assuming the policy 24 has not yet been sold as a life settlement. The collateral provider 26 can choose to extend the LOC 28, if needed, for an additional front end or back end fee paid by the policy owner or other interested party. Alternatively, the collateral provider 26 can choose not to renew the collateral posting, at which point, the insured can post acceptable collateral and assume the associated risk exposure. Or, a stand-by LOC provider could be secured, taking a fee or assignment of a portion of the death benefit of the policy 24 in exchange for providing a replacement letter of credit to take the place of the LOC 28 supplied by the original collateral provider 26.

Extension of the term loan period described above can allow the policy 24 to be sold as a life settlement at a later time, or allow for simple retention of the policy by the policy owner 12. In the event of such a sale, the lender 16 can be reimbursed from the proceeds of the life settlement sale for any additional expenses incurred.

In a related scenario, if expiration of the term loan period is near and the health of the insured has worsened, the policy owner 12 may desire to retain the policy 24 in anticipation of imminent death, notwithstanding the fact that the required period for posting the LOC 28 by the collateral provider 26 is about to expire. In this situation, the policy owner 12 can choose to allow the collateral provider 26 to exit the transaction, as above, thereby requiring the insured to assume the collateral risk by providing a LOC or other acceptable form of collateral. Alternatively, in lieu of assuming the collateral risk, the insured could pay an additional fee to the LOC provider to extend its collateral coverage for an additional period.

As another option, the policy owner 12 can simply choose to walk away from the transaction at the expiration of the term loan period. If this occurs, the policy 24 can be assigned to the collateral provider 26, thereby enabling further return on the exposure taken in posting the LOC 28.

More generally, risk to the parties involved in the life insurance transaction as described above in connection with the present embodiment is minimized or eliminated, in comparison with known strategies. The loan 20 issued by the lender 16 is secured by the policy 24, as well as by the LOC 28 supplied by the collateral provider 26. In turn, the collateral provider 26 provides the LOC 28, which is all but cosmetic and presents a low risk to the collateral provider, given the stability of the life insurance transaction. Furthermore, the collateral provider 26 receives a fee for supplying the letter of credit, which adds to its portfolio. In addition, because of its relationship to the transaction, the collateral provider 26 is ideally positioned to purchase the policy within the term loan period as the life settlement buyer if it chooses to do so, thereby enabling further profit to be received by marketing the policy on the secondary market.

Significantly, the policy owner 12 is also shielded from risk in that no monetary outlay is required to secure the policy, as the premiums are paid by the lender 16. The additional collateral needed to secure the loan is provided by the collateral provider 26, not the insured, as was the case in known strategies. Additionally, the policy owner 12 can directly or indirectly gain from the sale of the policy within the term loan period, as described above, via the life settlement created when the policy is sold. Thus, the present embodiment can represent a significant boon to the policy owner in terms of estate planning.

Note that the various figures and numbers discussed above in connection with FIGS. 3A-D, e.g., death benefit, term loan period, financed premiums, etc., can be adjusted as needed for a particular situation or insured. In light of this, it should be understood that the figures and discussion contained herein are merely exemplary of the broader principles taught by the present invention, and should not be construed as being limiting of the present invention in any way.

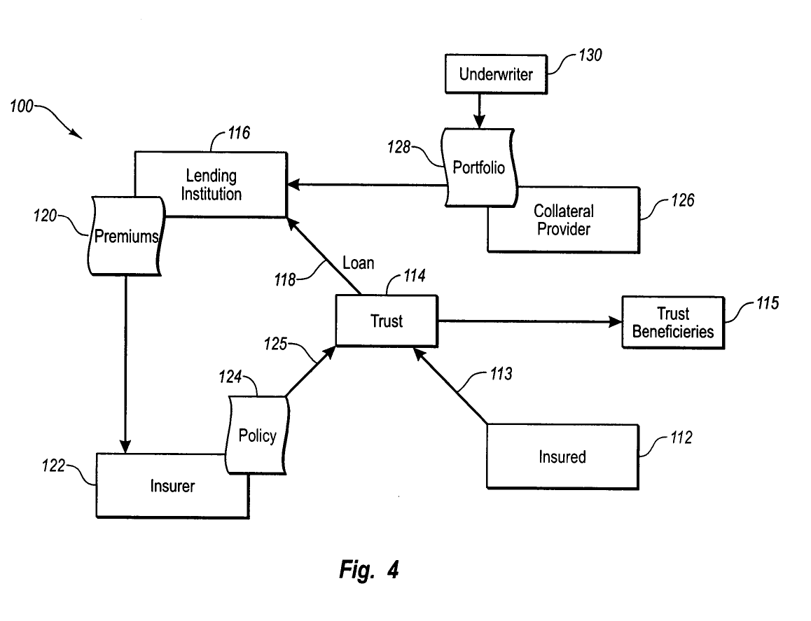

Reference is now made to FIG. 4 in describing another embodiment of the present invention. In detail, FIG. 4 shows an exemplary transaction scenario, generally depicted at 100, in which various details of an embodiment of the present invention are described. As can be seen, various of the parties in FIG. 4 are identical to those described in connection with FIG. 1. As such, extensive description of such parties, or their role in the transaction to be described, will not be given to the extent that it is similar to what has already been discussed.

In detail, the scenario 100 includes an insured 112 on whose life an insurance policy will be opened, as described herein. In contrast to the previous embodiment shown in FIG. 1, the policy owner is not the insured, but rather a trust 114 having trust beneficiaries 115. In one embodiment, the trust 114 is an irrevocable life insurance trust (“ILIT”), though in other embodiments other suitable types of trusts can be employed. As indicated by arrow 113, in the present embodiment the insured has irrevocably transferred assets to the trust 114, i.e., a life insurance policy to be described below.

A loan, indicated at 118, is arranged and executed between the trust 114 and a lending entity, such as a lending institution (“lender”) 116, or other suitable entity for the payment of premiums due on the life insurance policy. Again, in contrast to the previous embodiment the trust, not the insured, is a party to the loan with the lender 116. In other embodiments, however, the trust can be removed from the scenario such that the insured is a party to the loan. In return for the payment of policy premiums, the trust 114 is obligated to pay back the loan with interest, commensurate with premium financed life insurance transactions.

The lender pays the agreed-upon premiums, indicated at 120, to an insurance provider (“insurer”) 122 or other suitable entity, and a life insurance policy 124 is opened on the life of the insured 112 and delivered to the trust 114, as indicated by arrow 125, as a trust asset.

FIG. 4 further depicts a collateral provider 126 that is involved as a third party in posting collateral to cover any risk exposure by the lender 116, as described above. In contrast to the previous embodiment, however, the collateral does not take the form of a letter of credit, but rather a portfolio 128 of life insurance policies that are guaranteed, or “wrapped,” with a guarantee of liquidity by a specified maturity date, as will be explained. The guarantee of liquidity, or “wrap,” is provided to the portfolio 128 by an underwriter 130, such as an insurance company or other entity that can provide such a guarantee.

As mentioned, the portfolio 128 is composed of a bundled plurality of life insurance policies. In the present embodiment, the polices have been purchased by the collateral provider 126 from the life settlement secondary market, and as such, are each life settlement policies. Before purchase, life settlement policies, such as those bundled together in the portfolio 128, are appraised to assign a value thereto. The appraisal can be performed by the collateral provider 126 or by another entity.

In brief, the appraisal of the life settlement policy includes estimating the date on which the policy will be liquidated, i.e., the date when the life settlement insured is expected to have died. This can be determined using a variety of analyses and factors, including the current health status and future prognosis of the life settlement insured. The ratio between the premiums paid and the death benefit is also determined. These data are compiled in order to calculate a certified life expectancy (“LE”) for the life settlement policy before purchase. This appraisal and certification process is followed for each life settlement policy that is to be purchased. Similar purchased life settlement policies, i.e., those policies that have similar certified LE profiles, can be bundled together to form a portfolio, such as the portfolio 128 in FIG. 4, for use in collateralizing a premium financed life insurance transaction, such as that shown at 100. The bundled portfolio 128 can contain tens, hundreds, or thousands of life settlement policies, depending on the needs of the particular collateralizing scenario.

Once bundled, a guarantee of liquidity, also referred to herein as a“wrap,” can be placed on the portfolio 128. The guarantee of liquidity is a surety, or an assurance by the entity issuing the wrap, i.e., the underwriter 130, that each life settlement policy in the bundled portfolio 128 will be liquidated by a specified maturity date. In the event that each policy is not liquidated by the maturity date, the underwriter 130 will provide payment on the death benefit of those policies not yet liquidated, thereby providing security in the maturity of the bundled portfolio 128. Before providing such a wrap, the underwriter 130 will examine the portfolio and the life settlement policies of which the portfolio is composed for satisfactory characteristics in many policy aspects, including insurance company rating standards, policy contestability periods, premium payment history, premium reserves, interest reserves, maximum/minimum policy face amounts, actuarial certainty, the number of policies in the portfolio in order to invoke the beneficial law of large numbers, etc. Preferably, the underwriter issuing the wrap has at least an S&P “A” or “AA” rating or equivalent.

When guaranteeing the portfolio 128, the underwriter 130 in one embodiment provides a wrap that is sufficient to cover the composite margin of error represented in the certified LEs of the life settlement policies. In other words, if the composite margin of error of the portfolio 128 is 25%, which indicates that 25% of the life settlement policies may not be liquidated by the maturity date, a wrap covering 30% of the portfolio will be issued by the underwriter 130 in order to more than compensate for any projected margin of error on life settlement policy liquidity. A portfolio, such as the portfolio 128, containing a bundle of life settlement life policies with certified LEs that are wrapped with a guarantee of liquidity, is also referred to herein as a “performance bond,” given its resemblance to a secure investment instrument, similar to general bonds known in the art. Thus, in the present embodiment the portfolio 128 can be also referred to as a performance bond.

In the present and other embodiments described herein, the life insurance policies included within the portfolio are described as policies issued within the United States of America by insurance providers having at least an S&P rating of A, or equivalent. It is appreciated, however, that in alternative embodiments, policies issued in other countries by providers having suitable ratings could also be used in forming portfolios.

Together with FIG. 4, reference is now also made to FIGS. 2 and 3. The arrangement of a premium financed life insurance transaction as that described above in connection with FIG. 4 can be practiced utilizing the method described above in connection with FIG. 2, which includes stages 40-44. In addition, FIGS. 3A-D can be used in describing various details of the present embodiment. As before, FIGS. 3A-D describe a premium financed life insurance transaction for a 55 year-old male insured and includes columns A-Q. Note however that, as before, the same principles apply to insured persons, male and female, of a variety of ages. As was described in connection with the previous embodiment, column 8 shows that collateral is required to be posted for policy years 1-14. In accordance with the present embodiment, this collateral can be posted by the collateral provider 126 shown in FIG. 4. The collateral provided by the collateral provider 126 is the portfolio 128, which includes a wrapped bundle of life settlement life insurance policies having a guaranteed liquidity by a specified maturity date, as explained above. As such, no collateral is required to be posted by the trust 114 or the insured 112, thereby eliminating risk exposure for these parties.

The maturity date of the portfolio 128 is such that such that full liquidity of the portfolio, i.e., liquidation of each life settlement policy of the portfolio, is realized before expiration of term loan period. This ensures that the portfolio is able to act as a full collateral piece for the loan executed by the lender 116. For instance, the portfolio 118 used as collateral for the transaction shown in FIGS. 3A-D could have a guaranteed maturity date of five years, for example, well within the term loan period of 15 years.

The value of the wrapped portfolio 128 at maturity is designed to equal the maximum projected amount of required collateral shown in column K of FIGS. 3A-D, or about $1.57 million required in year 10. Note, however, that the purchase price of the portfolio 128 will be a discounted fraction of the portfolio value at maturity. In some cases, the portfolio 128 can be purchased by the collateral provider at a price of 50% the full value at maturity.

The present embodiment illustrates a significant advantage in the art, in that traditional risk is eliminated from the parties to the life insurance transaction. As before, the loan issued by the lender 16 is secured by the policy held by the trust 114 or insured 112, as well as by the collateral posted by the collateral provider 126. As the maturity date of the portfolio 128 will be reached before expiration of the term loan period, the collateral provider is secured from risk that it would otherwise assume. Thus, traditional risk is removed from the collateral provider.

In addition, the insured 112 is also shielded from risk in that no monetary outlay is required to secure the policy (see column N, FIGS. 3A-D), as the premiums are paid by the lender 116. Again, the additional collateral needed to secure the loan is provided by the collateral provider 126, not the insured, as in known strategies. The collateral provider 126 is in turn secured by the wrapped portfolio, thereby eliminating risk to the collateral provider. As such, the strategy described in the present embodiment can be employed with insureds having a wide range of ages and financial standings, thereby enabling broad-based policy applicability.

In one alternative embodiment, the portfolio 128 can be replaced by a letter of credit that is supplied by the collateral provider 126. The letter of credit is in turn backed by a portfolio of wrapped life settlement policies, similar to the portfolio 128.

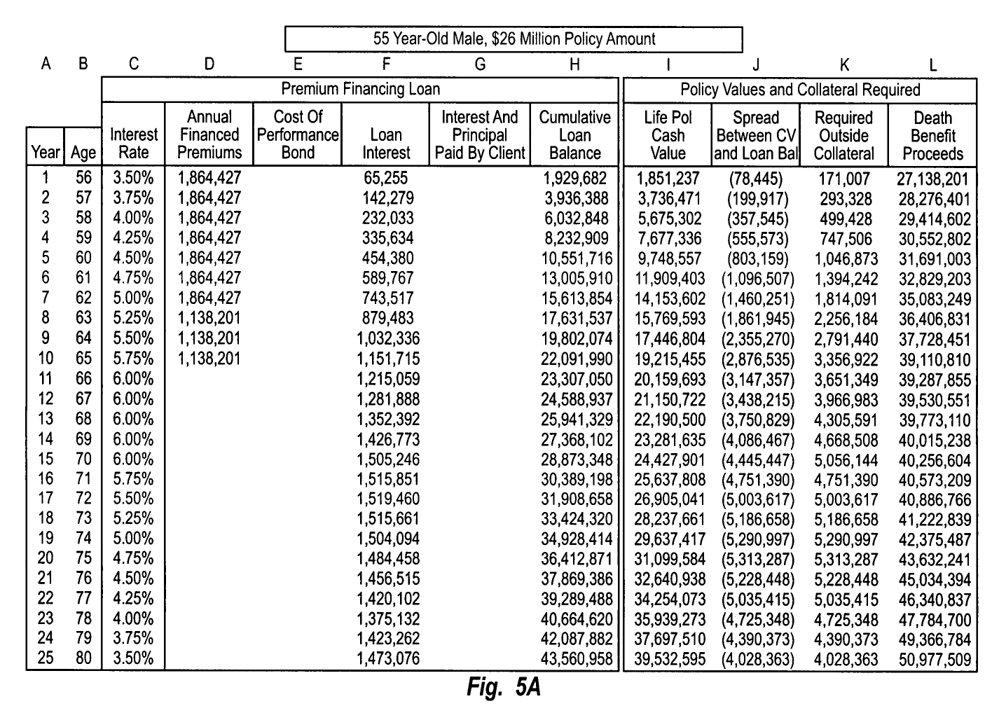

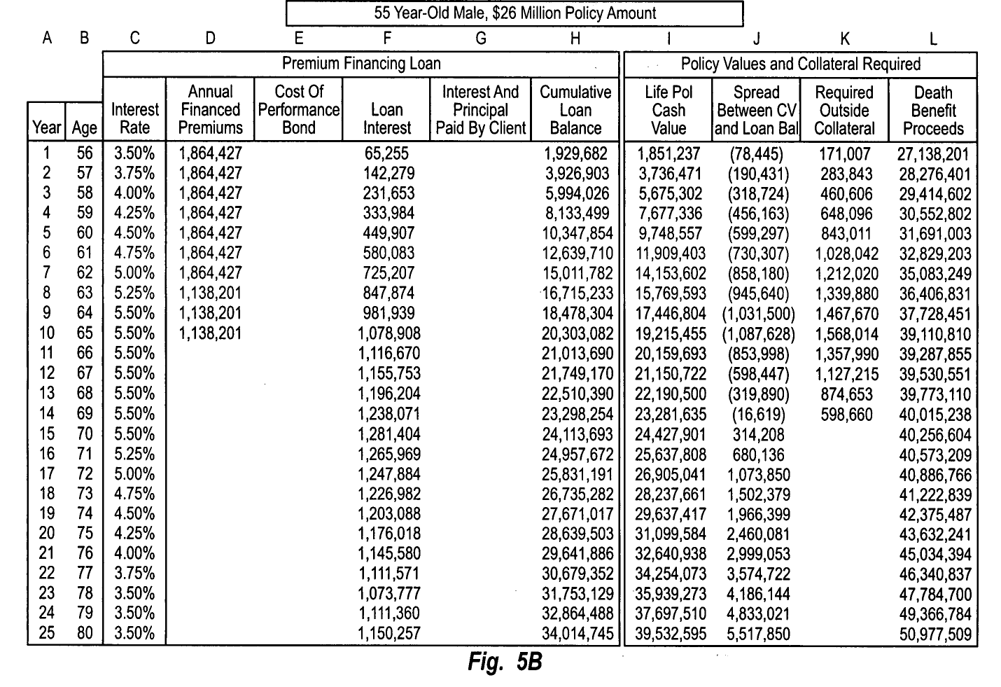

Notwithstanding the benefits outlined above in connection the embodiments of the present invention outlined in FIGS. 1-4, various factors may be present in certain insurance scenarios where application of the above methods may be limited. For instance, the interest rate shown in col. C of FIGS. 3A-D, which determines the amount of interest charged by the loan between the policy owner and the lender, is shown as a steady 3.5% rate. However, interest rates are commonly known to continually increase or decrease over time. It is possible that the interest rate can rise in relation to the crediting rate, which determines the gain in the cash value of the policy (col. I in FIGS. 3A-D), such that it exceeds the crediting rate for an extended period of time. This scenario is shown in FIG. 5A, in which a temporarily increasing interest rate, shown in col. C, dramatically increases the loan balance shown in col. H. In contrast, the policy cash value of col. I grows at a slower rate, due to the fact that the crediting rate is lower than the increased interest rate. This results in a negative spread between the cash value and the loan balance in col. J, and a corresponding increase in the amount of required collateral, as shown in col. K. While such a scenario can still be collateralized using the methods described in the previous embodiments, i.e., the required collateral is provided by a letter of credit or portfolio in order to remove the risk of posting collateral from the policy owner, the attractiveness of the transaction is tempered.

FIG. 5B shows a related scenario, wherein an increasing interest rate (col. C) is poised to dramatically increase the loan balance (col. H) over what would otherwise be present in a steady interest rate scenario. Here, however, the rate of loan balance increase is reduced by way of periodic payments made to the loan by the insured. This in turn reduces the amount of required collateral over what would otherwise be required, as shown in col. K. Again, while this scenario can still be collateralized using the methods described in the previous embodiments, i.e., the required collateral is provided by a letter of credit or portfolio in order to remove the risk of posting collateral from the policy owner, the attractiveness of the transaction is tempered.

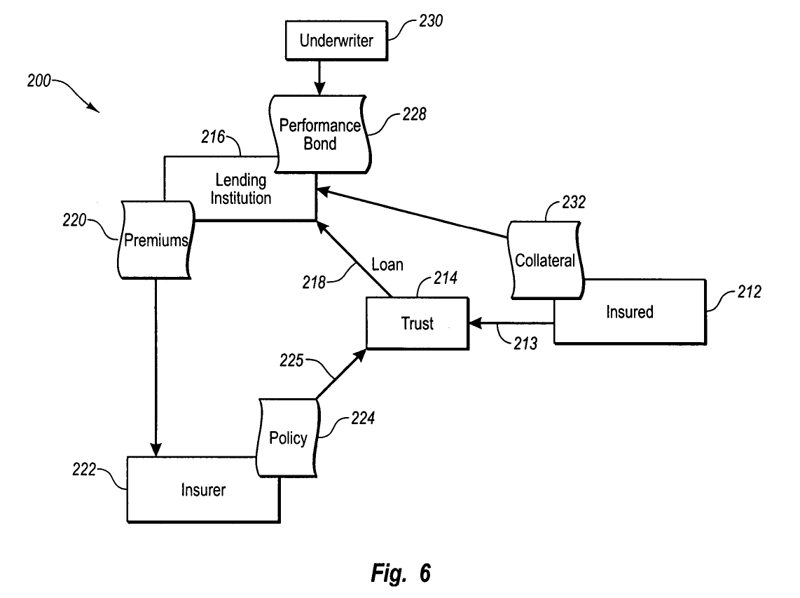

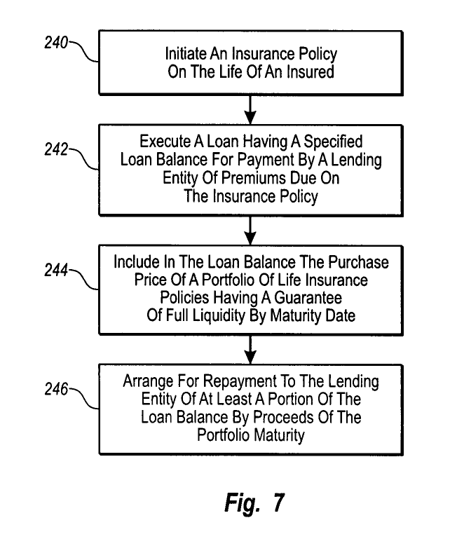

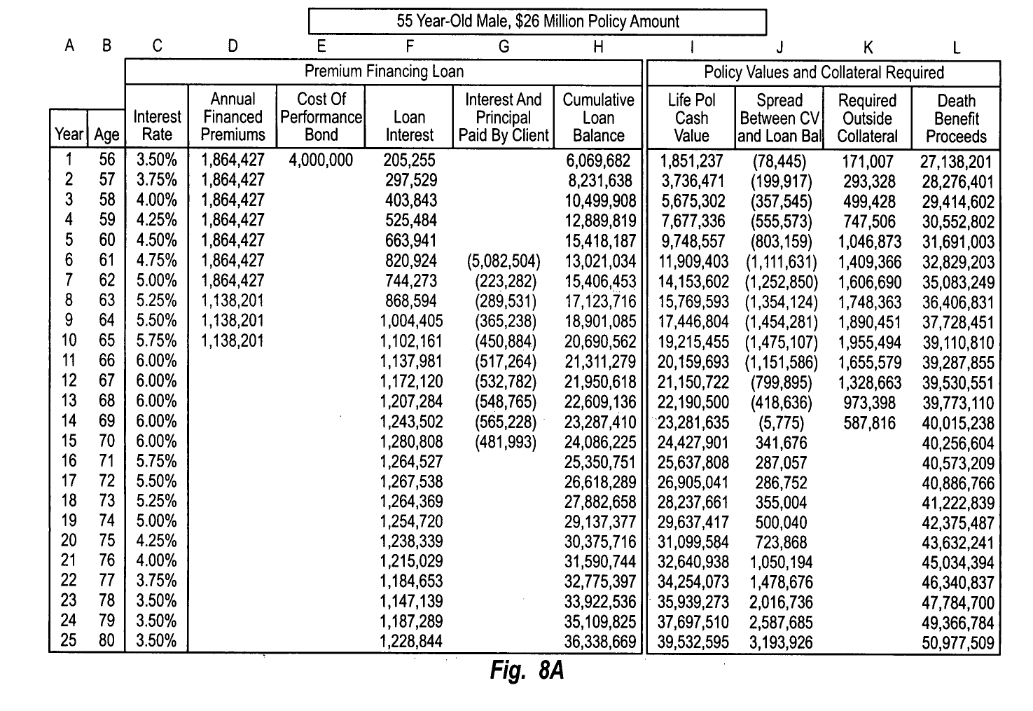

Reference is now made to FIG. 6. In light of the above scenarios, yet another embodiment of the present method for arranging a life insurance transaction while controlling risk exposure is disclosed. In detail, FIG. 6 depicts an exemplary transaction scenario, generally depicted at 200, in which the present method can be practiced. As can be seen, various of the parties in FIG. 6 are identical to those described in connection with FIGS. 1 and 4. As such, extensive description of these parties, or their role in the transaction to be described, will not be given to the extent that it is similar to what has already been discussed.

In detail, the scenario 200 includes an insured 212 on whose life an insurance policy will be opened using principles of a premium financed arrangement. The owner of the policy is a trust 214. In one embodiment, the trust 214 is an irrevocable life insurance trust (“ILIT”), though in other embodiments other suitable types of trusts can be employed. In other embodiments, the trust can be removed completely from the scenario. Here, as indicated by arrow 213, the insured 212 in the present embodiment has irrevocably transferred assets to the trust 214, i.e., a life insurance policy to be described below.

A loan, indicated at 218, is arranged and executed between the trust 214 and a lending entity, such as a lending institution (“lender”) 216, or other suitable entity for the payment of premiums due on the life insurance policy. Again, here the trust 214, not the insured 212, is a party to the loan with the lender 216. In other embodiments, however, the trust can be removed from the scenario such that the insured 212 is a party to the loan. In return for the payment of policy premiums, the trust 214 is obligated to pay back the loan with interest, commensurate with known premium financed life insurance transactions.

The lender 216 pays the agreed-upon premiums, indicated at 220, to an insurance provider (“insurer”) 222 or other suitable entity, and a life insurance policy 224 is opened on the life of the insured 212 and delivered to the trust 214, as indicated by arrow 225, as a trust asset.

As in the previous embodiment, a performance bond 228, i.e., a wrapped portfolio of life settlement life insurance policies having a guarantee of liquidity by a specified maturity date, is included in the transaction scenario 200. However, the performance bond 228 here is not provided by a third party, but rather by the lender 216. As before, the performance bond 228 is wrapped by a suitable entity such as an underwriter 230. The cost to purchase the performance bond 228 is included in the loan indicated at 218 for the payment of premiums. However, the performance bond 228 is designed to have a maturity date that occurs well before expiration of the term loan period. This fact, coupled with the stability and security of the bond by virtue of the appraisals, certifications, and wrappings included in its creation, serves to ensure that the performance bond fulfills a partial collateral capacity to secure the loan at 218 in favor of the lender 216.

As further depicted in FIG. 6, the insured 212 can be required to post collateral, indicated at 232 in order to cover any risk exposure of the lender 216 as a result of the spread between the balance of the loan at 218 and cash value of the policy 224. However, use of the performance bond 228 in partially securing the loan at 218 significantly reduces the amount of collateral posted, as will be shown.

With continuing reference to FIG. 6, reference is now made to FIG. 7. In accordance with the details depicted in FIG. 6, a method is disclosed in FIG. 7 for arranging a premium financed life insurance transaction having reduced risk exposure for the parties involved, in accordance with one embodiment. In a first stage 240, an insurance policy on the life of an insured is opened. In the transaction scenario 200 depicted in FIG. 6, for example, the life insurance policy 224 is opened by the insurer 222 on the life of the insured 212. In recognition of the fact that many species of life policies exist, the life insurance policy 24 of the present embodiment can take a variety of forms and be configured in a variety of ways.

In a next stage 242, a loan for the payment by a lender of premiums of the life insurance policy opened in stage 240 is executed. The loan has a specified loan amount. In the present transaction scenario 200, the executed loan is represented at 218 and is established between the trust 214 and the lender 216. Note that in an alternative embodiment, the loan can be established between the insured and the lender. Once the loan is executed, payment of the premiums is made by the lender 216 to the insurer 222 to keep the policy 224 in force on behalf of the trust 214. As was the case before, the loan for the payment of policy premiums can take a variety of forms, according to the parties involved, the particular economic situation in which the loan is executed, policy payment goals to be achieved, etc. Note that in an alternative embodiment, payment of premiums could be accomplished by an indirect route, i.e., from the lender to the trust or insured, then to the insurer 222. These and other payment schemes are therefore contemplated as being possible within this and the other scenarios discussed herein.

In a next stage 244, a wrapped portfolio of life settlement life insurance policies having a guarantee of full liquidity on or before a maturity date is purchased and the purchase price of the wrapped portfolio is included in the loan executed in stage 242. In the present embodiment, the wrapped portfolio that is purchased is a performance bond, such as the performance bond 228. The loan balance of the loan at 218 reflects the inclusion of the cost of the performance bond 228 placed therein. As mentioned, the maturity date of the performance bond 228 occurs before expiration of the term loan period of the loan at 218.

In a next stage 246, an arrangement is made for repayment to the lender of at least a portion of the loan balance by proceeds realized by maturity of the portfolio. In the present embodiment, once proceeds from the performance bond 228 are realized, they are used to pay down the loan balance in an amount equal to the initial cost of the performance bond rolled into the loan at 218 plus any interest accrued on the bond cost in the loan from the time of the cost roll-in to the time of payment.

Subsequent to the above payoff, the remaining proceeds of the performance bond 228 can be invested to earn interest. Then, periodic payments can be made to the loan at 218 to defer interest being charged by the lender 16 on the loan. In one instance, annual payments from the invested performance bond proceeds are made to the loan balance to pay off accrued interest in excess of that charged at a specified interest rate, such as 3.5%, thereby keeping the loan in effect as a loan charging 3.5% interest. Of course, the performance bond can be designed to pay off interest at other rates as well. This process can continue annually until the death of the insured, at which point the loan is satisfied by the death benefit of the policy 224, or until the proceeds of the performance bond 228 are exhausted, or until another intervening event cancels the loan.

The value of the performance bond 228 is selected in one embodiment according to the amount of accrued loan interest that is desired to be retired using the remainder of the performance bond proceeds following maturity of the portfolio, as explained above. The amount of accrued interest can be determined in turn by determining the threshold comfort level of projected future required collateral postings for the insured, who often is the party who will post collateral to cover any spread between the loan balance and the policy cash value. For instance, in the above hypothetical example, the performance bond value at maturity was chosen so as to enable it to not only pay off the bond purchase cost with accrued interest, but also to periodically payoff projected accrued interest above a 3.5% interest level for a predetermined number of years. This was so because the insured posting collateral would have had to have posted more collateral if the interest exceeded 3.5%, which as already described would increase the spread. Often, the interest rate of the loan can be projected as a “worst case” scenario with respect to the policy cash value in order to determine a high point for what the required collateral posting might be. This process of performance bond value determination and insured collateral posting threshold comfort level determination can be assisted by a coordinator, such as the coordinator 29 shown and described in connection with FIG. 1. In addition, a computer program product implementing computer-executable instructions that are designed to assist in these and other transaction-related determinations described herein can also be employed.

As mentioned, the effect of the above paydown on accrued interest of the loan at 218 is to reduce total loan balance of the loan at 218, thereby correspondingly reducing the spread between the loan balance and the cash value of the policy 224. This in turn reduces the amount of collateral that is to be posted the insured or by a third party, which reduces exposure risk to the posting party.

In an alternative embodiment, the performance bond is not purchased by the lender, but rather by the insured or the trust, pursuant an agreement for the cost of the bond to be rolled into the loan executed for the payment of premiums on the policy. Advantageously, the lender can forego requiring additional collateral to be posted by the insured or other posting party to cover the additional exposure of the lender in financing the bond purchase price. This is so, because of the stable and secure nature of the performance bond as an investment instrument, i.e., the virtual certainty that exists that the full liquidity, or value, of the performance bond will be realized at the maturity date, as guaranteed by the wrap provided by the underwriter 230. Note that securities and tax implications may attend the choice of which entity (lender, insured, or trust) is to purchase the performance bond. In addition, in some instances it may be possible for the performance bond purchaser to purchase several performance bonds at once, then “warehouse” them for future use once an appropriate insurance transaction can be arranged.

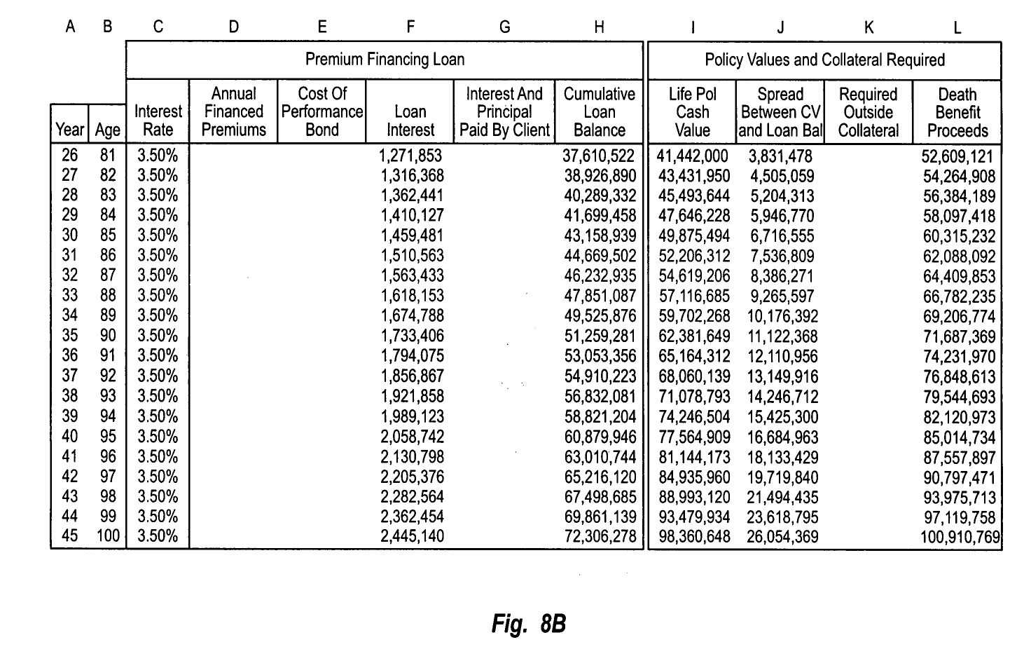

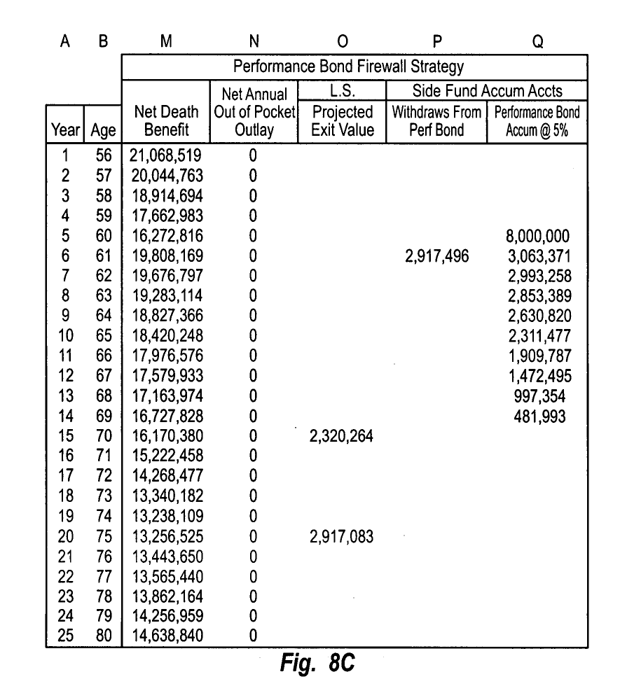

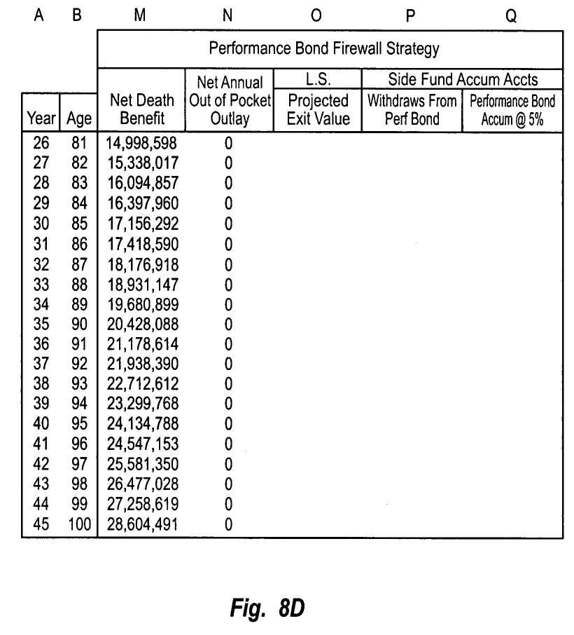

With continuing reference to FIGS. 6 and 7, reference is now made to FIGS. 8A-D , which shows an exemplary implementation of the method discussed above in connection with FIGS. 6 and 7. In particular, FIGS. 8A-D is a chart showing a premium financed life insurance transaction scenario involving a $26 million life insurance policy on the life of a 55-year old male insured. The chart of FIGS. 8A-D includes various columns A-Q that include various details regarding the premium financed life insurance transaction, including various aspects of the method shown in FIG. 7, according to one embodiment of the present invention. The parties to the transaction are those shown in FIG. 6. The format of the chart shown in FIGS. 8A-D is similar in many respects to other charts presented herein. As such, various details regarding the chart will not be discussed in depth here.

As shown in column D, the life insurance policy detailed in FIGS. 8A-D, i.e., the policy 224 of FIG. 6, is kept active via ten annual premium payments that are premium financed via a loan, such as the loan at 218 in FIG. 6. The loan at 218 used to pay the premiums accrues interest (col. F) at a variable rate shown in col. C. The interest rate in col. C begins in this scenario at 3.5% and increases to a max rate of 6% in policy years 11-15 (col. A) before descending to and remaining at 3.5% beginning at policy year 23. Column E further shows that a performance bond, such as the performance bond 228 of FIG. 6, having a value at its maturity date of $8 million, is purchased in policy year 1. The performance bond 228 is purchased at a discounted cost, typical of such bonds, for $4 million. The amount of performance bond to finance into the loan can vary from loan to loan and is dependent upon several factors, including the amount of collateral to be expected to be required during the loan— which is a partial function of the loan interest rate vs. the crediting rate at which the policy cash value grows— and the amount by which it is desired to lower the required collateral posting.

The cost to purchase the performance bond 228 is included in the loan, which is reflected in the loan balance of col. H at policy year 1, together with any accrued interest. Note that the lender 16 advantageously does not require any additional collateral posting for the financed cost of the performance bond 228, regardless of who the owner is of the performance bond, such as the lender itself, the insured 212, or some other party.

The performance bond 228 in the present embodiment is wrapped, and as such has a guarantee of liquidity by a specified maturity date, which occurs before expiration of the term loan period of 15 years, before renewal, in the present scenario. Column Q shows that the performance bond 228 here has a maturity date of five years, wherein the proceeds of the bond are realized that year in the amount of $8 million. A portion of the proceeds of the liquidated performance bond are then paid into the loan to pay off the cost of the performance bond, plus any interest that has accrued. This is shown in policy year 6 in col. G, wherein approximately $5.1 million is paid into the loan, thereby retiring the entire cost plus accrued interest of the performance bond 228.

As shown in col. Q, the remainder of the liquidated performance bond proceeds is invested to continue its growth. Concurrent to this, however, annual payments from the bond proceeds are made to the loan to continue paying down the accrued interest. In particular, an annual payment is made to the loan, from policy years 7 to 15 equal to the amount of accrued interest on the loan above and beyond a 3.5% interest rate accrual. This is continued until exhaustion of the bond proceeds, as shown in policy year 14 in col. Q.

The result of the above paydown is shown in cols. H-K. Column H shows that the loan balance grows at slower rate than would otherwise occur if the bond proceeds were not used to pay down accrued interest. This reduces the loan balance vs. cash value (col. I) spread shown in col. J. Correspondingly, the required collateral to be posted by the insured 212 or other party is reduced relative to what would be otherwise required. Indeed, cols. J and K demonstrate that the negative spread between loan balance and cash value terminates at policy year 14, much sooner than would otherwise occur. Correspondingly, this eliminates the need for any collateral posting as of policy year 15. Significantly, required collateral posting is reduced even though a negative arbitrage situation exists in the scenario of FIGS. 8A-D, wherein the loan interest rate exceeds the crediting return rate of the policy cash value, which was also seen in FIG. 5A and FIG. 5B. In this way, exposure risk is beneficially reduced for the lender and the insured in the premium financed transaction, thereby offering significant advantages over other known scenarios. In particular, the above transaction and related method helps to prevent a scenario where a large negative spread between loan balance and cash value exists, which otherwise can cause the loan to be called by the lender in certain circumstances.

In one embodiment, the method described in connection with FIGS. 6-8 is employed in situations where the insured is an individual having a net worth of at least $5 million. In other embodiments, however, the transaction can be designed such that individuals having a net worth less than $5 million can participate. In yet another embodiment, the method can be practiced in connection with philanthropic giving via a trust, wherein the death benefit proceeds are forwarded to a charity, for instance.

In an alternative embodiment, a non-wrapped portfolio could be employed in the performance bond described above, though such a portfolio may not be as desirable for the lender due to is lack of guaranteed liquidity.

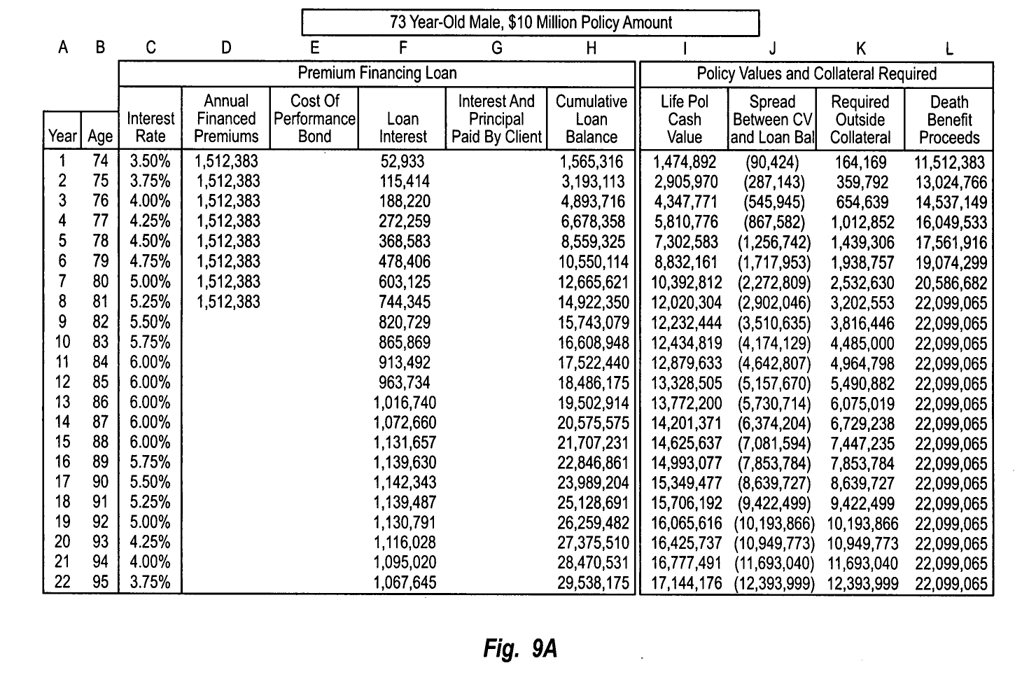

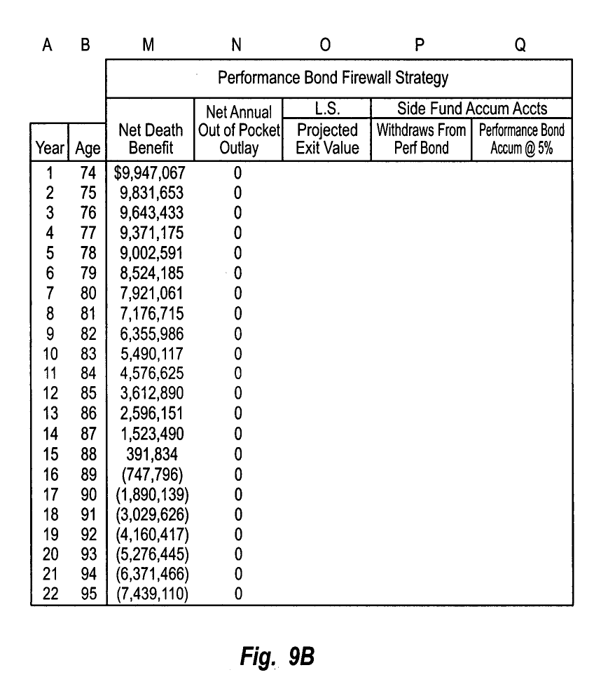

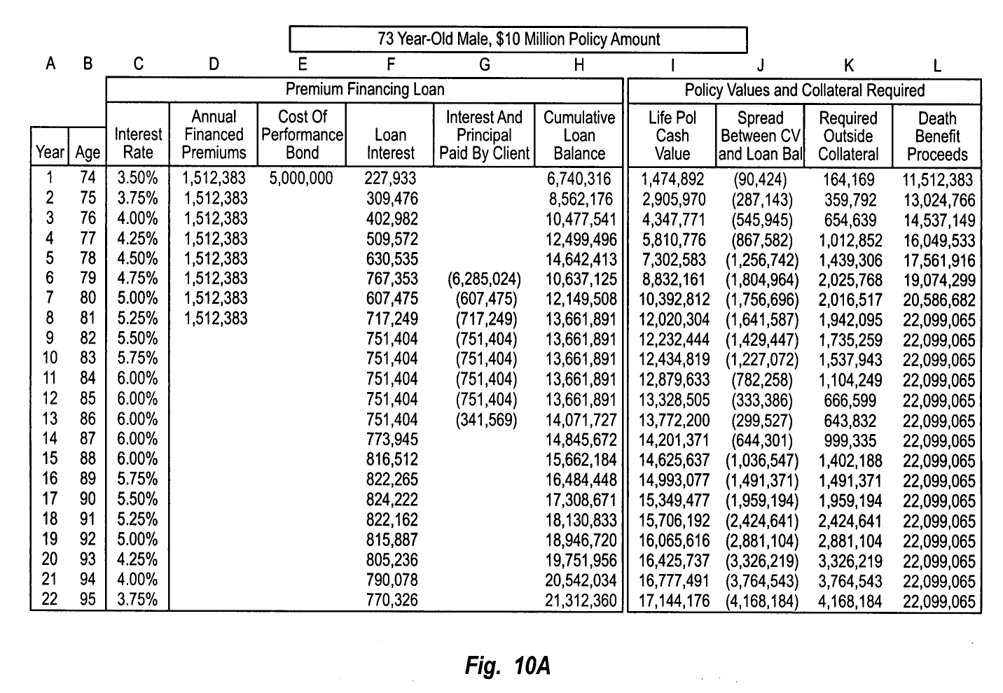

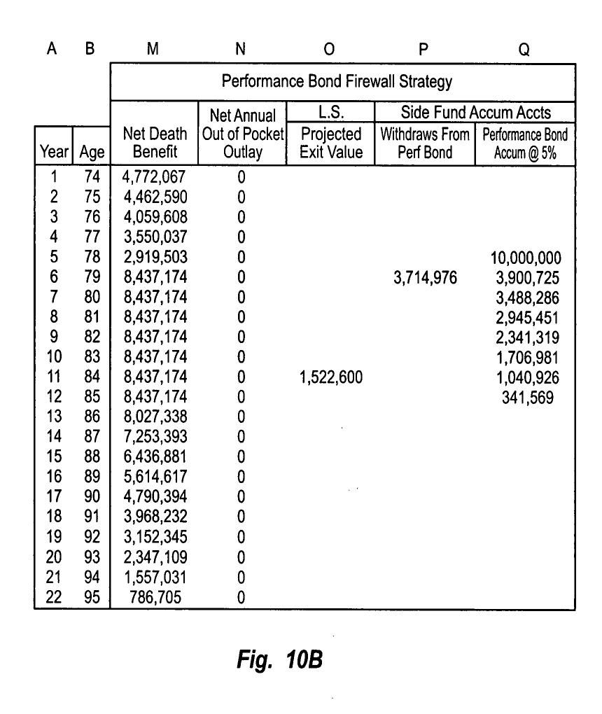

The beneficial effects of the method disclosed in connection with FIGS. 6-8 can be further seen in FIGS. 9 and 10. In detail, FIGS. 9A-B depicts a premium financed life insurance transaction for a 73 year-old male having a policy coverage amount of $10 million, configured in accordance with one of the embodiments described in connection with FIGS. 1-4. Notwithstanding the benefits achieved by practice of these embodiments in the present scenarios, it is nonetheless seen that, in an adverse interest rate vs. cash value crediting rate scenario as depicted in FIGS. 9A-B, that the spread indicated in col. J can increase dramatically over the policy life, thereby requiring high amounts of collateral (col. K) to be posted.

In contrast, FIGS. 10A-B shows application of the method disclosed in the embodiment discussed in connection with FIGS. 6-8—i.e., utilization of a performance bond, the cost of which is rolled into the loan created for the payment of policy premiums—to the same scenario shown in FIGS. 9A-B. As shown, a $10 million performance bond is purchased at $5 million and included in the loan at policy year 1 (col. E). Upon maturity of the performance bond, $10 million is available (col. Q), a portion of which is used to retire the bond purchase cost plus accrued interest at policy year 6 in col. G. Subsequent payments are made to loan, as seen in col. G, from the proceeds from the liquidated performance bond, which as before, reduces both the spread of loan balance vs. cash value and the required collateral to be posted. The beneficial effects of this can be seen by comparing cols. J and K of FIGS. 10A-B with cols. J and K of FIGS. 9A-B. In this way, even traditionally difficult life insurance transaction scenarios can be improved by use of the methods disclosed herein.

Note that, though the cost to purchase the performance bond is shown in these examples to occur at policy year 1, the purchase cost can be included in the loan balance during other policy years, if required. Also, lump sum payments to the loan balance in order to defer accrued interest can also be made, in lieu of incremental annual payments.

It is appreciated that in other embodiments, insurance policies that implicate a future interest benefit may be the subject of a policy, such as the policy 224 in FIG. 6, issued by the insurer pursuant a premium financed transaction. Thus it is conceivable that policies insuring the life of a non-human, e.g., a racehorse or other animal, could benefit from the principles taught herein.

Also note that, while depicted in the accompanying figures as singular entities, the lender and insurance provider can in one embodiment each be composed of multiple parties that cooperatively participate in the transaction.

Note that the embodiments discussed herein present solutions that are recyclable in the sense that an increasing supply of life policies are currently being marketed in the life settlement or secondary market, thereby making them subject to inclusion in wrapped portfolios. This ensures that the methods described herein can remain viable in future years.

It should be appreciated that the embodiments described herein can be employed in premium financed transactions that have been initially executed without the features of the present invention. For example, an insured who initially assumed the responsibility for providing the additional collateral required in a typical premium financed transaction can have the transaction adapted to incorporate one or more elements of the embodiments as described herein, thereby removing from the insured the collateral risk initially assumed. More generally, it should be appreciated that the embodiments described herein can be employed in traditionally non-premium financed insurance scenarios. For example, split-dollar or third party policy payor situations can evolve where the third party, such as a corporation, can no longer pay the premiums on the policy. In such a situation, a wrapped portfolio-backed collateral program could be initiated to guarantee the proceeds to make future premium payments. In another example, an insurance policy that suffers from underperformance, will typically cause a breakdown of policy values. In such a case, a wrapped portfolio-backed collateral program could be initiated to compensate for the underperformance and to achieve the desired policy value. In addition to these examples, other scenarios, such as annuity policies, can warrant practice of embodiments of the present invention.

The present invention may be embodied in other specific forms without departing from its spirit or essential characteristics. The described embodiments are to be considered in all respects only as illustrative, not restrictive. The scope of the invention is, therefore, indicated by the appended claims of this and related applications rather than by the foregoing description. All changes that come within the meaning and range of equivalency of the claims are to be embraced within their scope.

1. A method for structuring an insurance transaction, the method comprising:
coordinating the initiation of an insurance policy that relates to the life of a person;
coordinating the execution of a loan on behalf of an owner of the policy for the payment of premiums due on the policy; and
coordinating the posting of collateral for the loan by a third party.

2. A method for structuring as defined in claim 1, wherein the insurance transaction is a premium financed life insurance transaction.

3. A method of structuring as defined in claim 1, further comprising:
projecting the maximum required collateral to be posted during a term loan period of the loan, wherein the required collateral relates to the difference between an outstanding loan balance of the loan and an accumulated cash value of the policy.

4. A method for structuring as defined in claim 1, wherein coordinating the posting further comprises:
by the third party, coordinating the posting of a letter of credit as collateral for the loan; and
paying a fee to the third party as a result of posting the letter of credit.

5. A method for structuring as defined in claim 1, wherein the person is at least 75 years of age or possesses a net worth of at least $3 million.

6. A method for structuring as defined in claim 1, wherein the person on whose life the policy is initiated is the owner of the policy.

7. A method of arranging a premium financed life insurance transaction, the method comprising:
initiating an insurance policy on the life of a person;
executing a loan having a specified loan balance for payment by a lending entity of premiums due on the insurance policy;
including in the loan balance the purchase price of a portfolio of life insurance policies, the portfolio having a maturity date; and
arranging for repayment to the lending entity of at least a portion of the loan balance by proceeds of the portfolio at maturity.

8. A method of arranging as defined in claim 7, wherein the portfolio includes a guarantee of full liquidity by the maturity date.

9. A method of arranging as defined in claim 8, wherein the guarantee of liquidity is issued by an underwriter having an S&P rating of A or above.

10. A method of arranging as defined in claim 8, wherein the guarantee of liquidity covers a portion of the anticipated liquidity of the portfolio greater than the margin of error of the maturity date.

11. A method of arranging as defined in claim 7, wherein at least one of initiating the insurance policy, executing the loan, including in the loan balance, and arranging for repayment is coordinated by a coordinator.

12. A method for managing risk exposure of parties to a premium financed life insurance transaction, the life insurance transaction including a policy issued by an insurance provider on the life of a person, the policy requiring payment of premiums, the premiums being paid by a lending entity via a loan executed between an owner of the policy and the lending entity, the lending entity requiring a posting of collateral for the loan, wherein the method comprises:
coordinating the purchase of a portfolio of life settlement life insurance policies having a guarantee of liquidity at a predetermined maturity date, wherein the portfolio secures a portion of the loan.

13. A method for arranging as defined in claim 12, wherein the maturity date occurs before expiration of a term loan period of the loan.

14. A method for arranging as defined in claim 13, wherein the cost to purchase the portfolio is included in the loan amount.

15. A method for arranging as defined in claim 14, wherein the portfolio purchase is coordinated such that no additional collateral posting is required for the purchase cost of the portfolio that is included in the loan balance.

16. A method for arranging as defined in claim 15, wherein proceeds from the portfolio liquidity are used to reduce the loan balance an amount equal to the purchase cost of the portfolio plus accrued loan interest.

17. A method for arranging as defined in claim 16, wherein a remainder of the proceeds from the portfolio liquidity is used to reduce a portion of the loan balance created by accrued interest.

18. A method for arranging as defined in claim 17, wherein reduction of a portion of the loan balance created by accrued interest is repeated periodically until exhaustion of the remainder of the proceeds.

19. A method for arranging as defined in claim 12, wherein coordinating the purchase further comprises at least one of the following:
identifying a lending entity suitable for the premium financed life insurance transaction; and
identifying a suitable portfolio for purchase and use in the premium financed life insurance transaction.

20. A method for managing as defined in claim 12, wherein coordinating the purchase further comprises:
by a party to the loan, coordinating the purchase of a portfolio of life settlement life insurance policies.

21. A method for arranging as defined in claim 12, wherein the posting of collateral is performed by the person on whose life the policy is issued.

22. A method for arranging as defined in claim 12, wherein coordinating the purchase further comprises:
coordinating the purchase of a portfolio of life settlement life insurance policies having a guarantee of liquidity at a predetermined maturity date, wherein the purchase cost is less than the value of the portfolio at maturity.

23. A method for arranging as defined in claim 12, wherein coordinating the purchase further comprises:
by a computer program product, coordinating the purchase of a portfolio of life settlement life insurance policies having a guarantee of liquidity on or before a predetermined maturity date, wherein the computer program product includes computer-executable instructions that, when executed by a processor, cause a computing system to perform the at least one of the following:
determining a projected maximum required amount of collateral posting during the term loan period; and
determining the purchase cost of the portfolio such that, when liquidated, proceeds of the portfolio are sufficient to reduce the loan balance and correspondingly reduce the required amount of collateral posting.

24. A method for structuring a premium financed life insurance transaction, the life insurance transaction including a policy issued by an insurance provider on the life of a person, the policy requiring payment of premiums, wherein the method comprises:
coordinating the establishment of a trust as an owner of the policy; and
coordinating the execution of a loan between the trust and the lending entity for payment by the lending entity of the premiums of the policy, wherein a portfolio of life settlement life insurance policies is purchased, the portfolio having a guarantee of liquidity by a predetermined maturity date, the purchase cost of the portfolio being included in the loan.

25. A method for structuring as defined in claim 24, wherein the trust is an irrevocable life insurance trust.

26. A method for structuring as defined in claim 24, wherein the portfolio assists in facilitating execution of the loan by the lending entity.

27. A method for structuring as defined in claim 24, wherein the portfolio is purchased by the trust.
